(19) United States
(12) Patent Application Publication
(10) Pub. No.: US 2007/0079092 A1
(43) Pub. Date: Apr. 5, 2007

(54) System and method for limiting access to a storage device

(76) Inventors: Junichi Hara, Cupertino, CA (US); Shoji Kodama, Sagamihara (JP); Akira Yamamoto, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/240,456

(22) Filed: Oct. 3, 2005

(51) Int. Cl. G06F 12/14

(52) U.S. Cl. 711/163; 711/114

(57) ABSTRACT

An apparatus, system, and method by which, if hard disk drives used within disk array systems are removed and installed in another disk array system or attempted to be accessed by another device, data in the hard disk drives cannot be accessed. In one embodiment, a disk array system sets a password onto each hard disk drive. The hard disk drives reject access from disk array systems or computer systems until a correct password is input. In alternative embodiments, hard disk drives memorize one or more World Wide Names (WWNs) of the disk array system. After memorizing a WWN, the hard disk drives allow access only from the disk array system having the same WWN as the one that the hard disk drives memorized. Thus, the hard disk drives are normally inaccessible after they are removed from a disk array system.

### BACKGROUND OF THE INVENTION

1. Field of the Invention

The invention relates generally to disk array systems and hard disk drives installed and managed within the disk array systems, and, more particularly, to a system, method and apparatus for preventing unauthorized access to hard disk drives.

2. Description of the Related Art

In recent years, with the increase of storage capacity in disk array systems, the number of hard disk drives (HDDs) installed and managed within disk array systems has been steadily increasing. In high-end disk array systems, hundreds of HDDs may be installed and managed. Additionally, the importance of storage security has been increasing due to the occurrence of corporate data leaks, corporate espionage, identity theft, and the tightening of government regulations regarding data storage and protection. However, in conventional disk array systems, if an HDD is removed from one disk array system, and if the HDD is installed into another disk array system, or other computer system having an access device capable of accessing data stored on an HDD, the data stored on the HDD can usually be accessed, regardless of whether such access is authorized.

As is known in the prior art, to prevent unauthorized access to data in an HDD, the data may be encrypted before it is written on the HDD. Encryption entails altering the actual data code into a secret code, which must be decoded using a key when retrieved from the HDD before the data can be used. Thus, if an unauthorized user installs an encrypted HDD into another disk array system to attempt to gain access to the data on the HDD, the data will be meaningless if it is not properly decrypted. However, there are several substantial drawbacks to the use of encryption, including the requirement for additional hardware and/or software for conducting the encryption/decryption function. Additionally, encryption reduces the performance of the disk array system because of the delay necessary for the encryption mechanism to encrypt and decrypt the data.

In a prior art method disclosed in U.S. Pat. No. 5,375,243, to Parzych et al., the disclosure of which is hereby incorporated by reference in its entirety, unauthorized access to an HDD is prevented by placing an access password on the HDD itself. Access to the HDD is rejected until the correct access password is input to the HDD. However, this prior method is intended to be used with a personal portable computer system, so that the password must be input manually by a user at the time of first use, or by the manufacturer at the time of manufacture. Accordingly, if this prior system were to be used with a disk array system, users or administrators of the disk array system would have to manually input passwords for each of the hundreds of HDDs installed in the disk array system, or obtain the password for each HDD from the manufacturer, and manually set up and manage the passwords relative to each of the HDDs. Further, use of the prior art method in a disk array system would create issues with password maintenance and security for keeping track of, updating and protecting the passwords for the numerous HDDs, particularly if it is necessary to replace HDDs and install new HDDs.

### BRIEF SUMMARY OF THE INVENTION

An object of the present invention is to prevent unauthorized access to HDDs used within disk array systems. A further object of the invention is to prevent unauthorized access to HDDs after the HDDs are removed from the disk array systems.

In a first embodiment, a disk array system may include an access device, such as a controller, and a plurality of HDDs. The controller generates random passwords and sets them to the HDDs and manages the correlation of the passwords and the HDDs. The HDDs reject access from the controller by rejecting attempted login access, and respond to only a limited set of commands until the controller transmits the correct password to the HDDs.

In a second embodiment, the HDDs detect the WWN of the controller and memorize this WWN. After that, the HDDs allow access only from an access device, such as a controller having the same WwN as the one that the HDDs memorized. The HDDs reject access from controllers having different WwNs from the one that the HDDs memorized by rejecting login requests from other controllers.

In a third embodiment, the HDDs detect the WWNs of multiple controllers in communication with the HDDs, and memorize these WWNs. After that, the HDDs allow access only from a controller having the same WWN as one of the WWNs that the HDDs memorized. The HDDs reject access from controllers having different WWNs from the WWNs that the HDDs memorized by rejecting login requests from the controllers having the different WWNs and preventing access to data stored on the HDDs.

These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example configuration of a disk array system to which the present invention is applied.

FIG. 2 illustrates an example configuration of an HDD for use with the invention.

FIG. 3 illustrates a functional diagram of the disk array system illustrated in FIG. 1.

FIG. 4 illustrates a typical structure of a frame for use with the invention.

FIG. 5 illustrates an exchange of information between a transmitting party and a name server.

FIG. 6 illustrates an exchange of information between a transmitting party and a destination party.

FIG. 7 illustrates a structure of a data field when a frame of the Fibre Channel standard transmits the Inquiry command defined by the SCSI standard.

FIG. 8 illustrates the inquiry sequence of the logical unit by using the Inquiry command.

FIG. 9 illustrates an exemplary structure of an FCP_CDB of the Password command.

FIG. 10 illustrates a password management table for use with the invention.

FIG. 11 illustrates a status byte code returned by a destination party in response to a Password command.

FIGS. 12A-12B illustrate a flow diagram of a process for accessing the HDDs with password protection, and the password management process in the HDD password manager of the invention.

FIG. 13 illustrates a flow diagram of processing a password command in an HDD password memorizing module in the HDD of the invention.

FIG. 14 illustrates a password accepted list.

FIG. 15 illustrates a flow diagram of processing of the inquiry command in the HDDs of the invention.

FIG. 16 illustrates a functional diagram of a disk array system of a second embodiment of the invention.

FIG. 17A and 17B illustrate a flow diagram for accessing HDDs of the second embodiment and for memorizing a WWN in the WWN memorizing module when the HDD receives the login request.

FIG. 18 illustrates an example of a disk array system for use with a third embodiment of the invention.

FIG. 19 illustrates an example configuration of an HDD for use with the third embodiment of the invention.

FIG. 20 illustrates a functional diagram of the disk array system illustrated in FIG. 18.

FIG. 21 illustrates a flow diagram of memorizing WWNs in the WWN memorizing module when the HDD receives the login request.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like reference numerals describe substantially similar components throughout the several views.

First Embodiment—System Configuration:

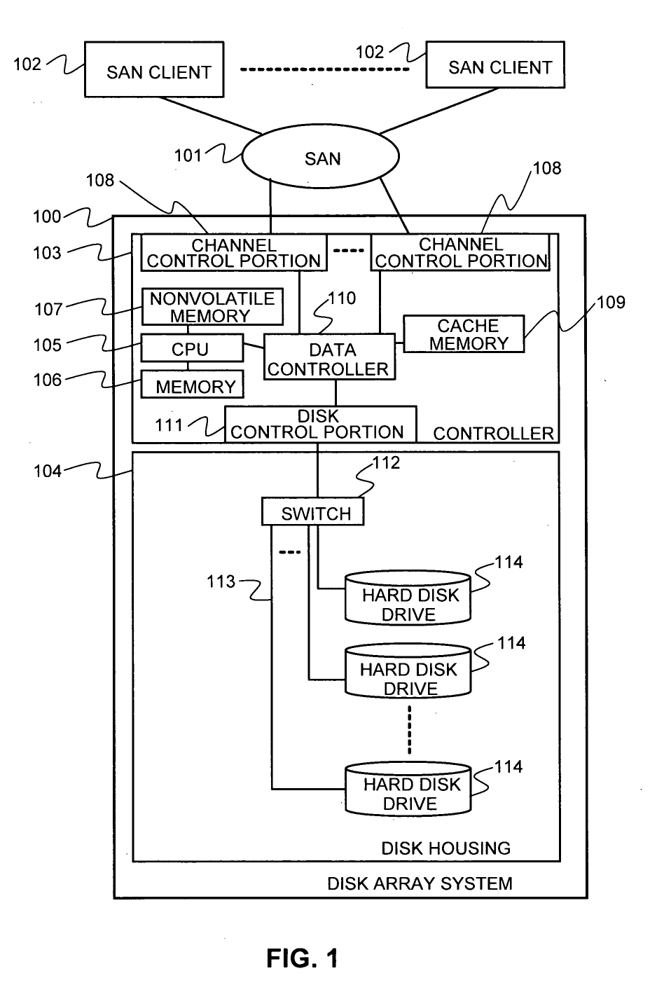

FIG. 1 shows an example configuration of a disk array system in which the method in this invention is applied. As illustrated in FIG. 1, one or more SAN clients 102 are connected to a disk array system 100 through a SAN (Storage Area Network) 101. The SAN 101 is composed of switches and cables so as to be able to establish communication conforming to an FC-SW (Fibre Channel Switched Fabric) standard between the SAN clients 102 and the disk array system 100. The SAN clients 102 are, for example, personal computers, work stations, mainframe computers, or the like.

The disk array system 100 includes an access device, such as a controller 103, a disk housing 104. The controller 103 may include a CPU 105, a memory 106, a cache memory 109, channel control portions 108, a data controller 110, a disk control portion 111, and a nonvolatile memory 107.

The disk housing 104 comprises a plurality of hard disk drives (HDDs) 114, and a switch 112. The HDDs 114 in the disk housing are connected to the disk control portion 111 through cables 113 and switch 112 so as to be able to establish communication with the disk control portion 111 of controller 103 for enabling controller 103 to communicate with and access HDDs 114.

Disk control portion 111 is an interface for exchanging data with HDDs 114 in accordance with an instruction from the CPU 105. The disk control portion 111 has a function of transmitting a data input/output request to the HDDs 114 in accordance with a protocol setting forth commands, etc., for controlling the HDDs 114.

The CPU 105 administers the control of the disk array system 100 as a whole. The CPU 105 executes micro-programs stored in the memory 106, so as to control the channel control portions 108, the disk control portion 111, the data controller 110, and the like.

The cache memory 109 serves to temporarily store data to be exchanged between each channel control portion 108 and disk control portion 111. The data controller 110 performs data transfer between each channel control portion 108 and the cache memory 109, or between the cache memory 109 and the disk control portion 111 under the control of the CPU 105.

The nonvolatile memory 107 serves to preserve various management information and management tables. In the first embodiment, CPU 105 stores a password management table 1000 in the nonvolatile memory 107, as will be described further below with reference to FIG. 10.

The controller 103 in the preferred embodiment has a function of controlling the HDDs 114 under a RAID level (for example, 0, 1 or 5), conforming to a so-called RAID (Redundant Array of Inexpensive (or Independent) Disks) system. In a RAID system, a plurality of HDDs 114 is managed as one group (hereinafter referred to as a RAID group). Logical volumes serving as access units from the SAN clients 102 are formed on each RAID group. An identifier referred to as an LUN (Logical Unit Number) is assigned to each logical volume. RAID configuration information is stored in the memory 106, and is referred to by the CPU 105 when the CPU 105 executes the data READ process or the data WRITE process.

The disk control portion 111 is connected to a plurality of HDDs 114 through a switch 112 conforming to the FC-SW (Fibre Channel Switched Fabric) standard. The HDDs 114 are connected to the switch 112 with one or more of the cables 113.

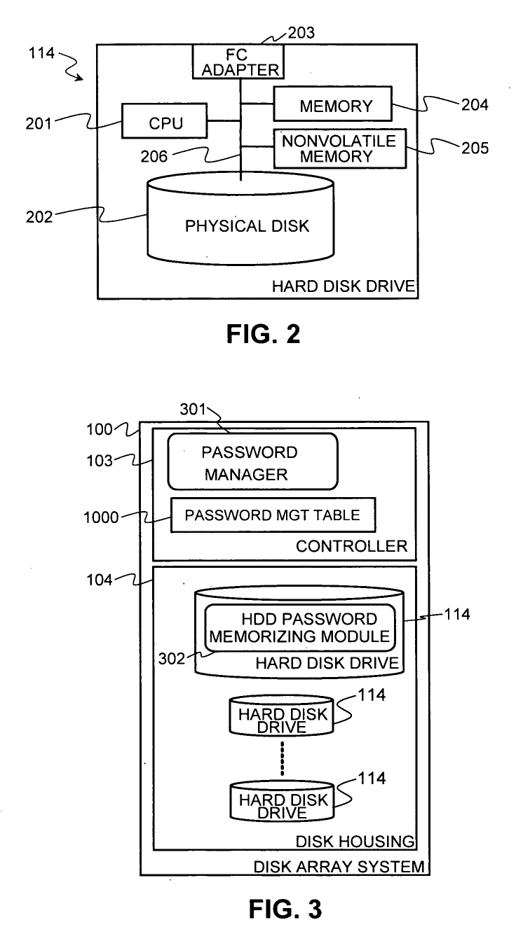

As illustrated in FIG. 2, each HDD 114 may be a hard disk drive having an FC adapter 203 for providing a communication function conforming to the FC-SW standard. Also, each HDD 114 has a CPU 201 and a memory 204 to process a data input/output request from the disk control portion 111. Each HDD 114 may also include a nonvolatile memory 205 to preserve various management information and management tables, and a physical disk 202. An internal bus 206 connects the components of the HDD 114 for enabling communication. In the first embodiment, a password set by the controller 103 is stored in the nonvolatile memory 205, or on the disk 202, or both.

Functional Diagram:

FIG. 3 shows a functional diagram of the disk array system 100 in FIG. 1. In the controller 103, there is a password manager 301. The password manager 301 generates random passwords and sets them to HDDs 114. Also, the password manager 301 manages correspondence between the passwords and the HDDs 114. To manage the correlation between passwords and individual HDDs 114, the password manager 301 stores the password management table 1000 (described further in FIG. 10) in the nonvolatile memory 107. Password manager 301 may be realized as a software module stored in nonvolatile memory 107, or other computer-readable medium, and executed by controller CPU 105.

In each of the HDDs 114, there is a HDD password memorizing module 302. The HDD password memorizing module 302 memorizes the password set by the password manager 301 in the controller 103, and after memorizing the password, rejects logins and other access attempts to the HDD 114 until the correct password is sent by the password manager 301. HDD password memorizing module 302 may be realized as a software module stored on nonvolatile memory 205, physical disk 202, or other computer-readable medium, and is executed by HDD CPU 201.

Standard Fibre Channel and SCSI commands

The following detailed description of the invention utilizes Fibre Channel protocol (FCP) as an example of an interface protocol used between a disk control portion 111 and HDDs 114, and an SCSI command set as an example of a command set operating on the interface protocol. However, the invention is not limited to the combination of the Fibre Channel protocol and the SCSI command set, but can be applied to any combination of protocols and interfaces so long as these can provide the functions and mechanisms of login, inquiry, logout, and so forth, as described below.

A device having an FC interface is referred to as a “node”, and a physical terminal corresponding to a practical interface is referred to as a “port”. The node can have one or more ports. The number of ports that can simultaneously participate in the overall system of the Fibre Channel protocol is the address number of a maximum of 24 bits, namely, 2²⁴ (16,777,216) ports. Hardware that mediates these connections is referred to a “fabric”. In practice, transmitting ports and destination ports need only operate by taking information related to the mutual ports into account, but without the necessity for taking the fabric into account.

Each of the nodes and ports stores a World Wide Name (WWN) identifier that is unique worldwide, and that is allocated by IEEE (Institute of Electrical and Electronics Engineers) in accordance with a predetermined procedure. A WWN is a 64-bit address that is used within the Fibre Channel specification for assigning a unique ID to each element within a Fibre Channel fabric and is handed out to vendors from the IEEE. The format is as follows:
A worldwide unique identifier for the NODE;
A worldwide unique identifier for each N_PORT associated with the node; and
For each N_PORT attached to a fabric, a 24-bit fabric-unique address.
   The fabric address is the address to which frames are sent.

Thus, WWNs are similar to MAC addresses used in other protocols such as TCP/IP, and are hardware-fixed addresses. The WWN addresses include two kinds, i.e., N_Port_Name is a value (hardware address) unique to each port and Node_Name is a value (hardware address) unique to each node. Since these values are unique worldwide, they are capable of primarily identifying the ports and nodes. In the examples set forth in the invention, the term “WWN” typically represents an N_Port_Name, although other WWN values may also be used.

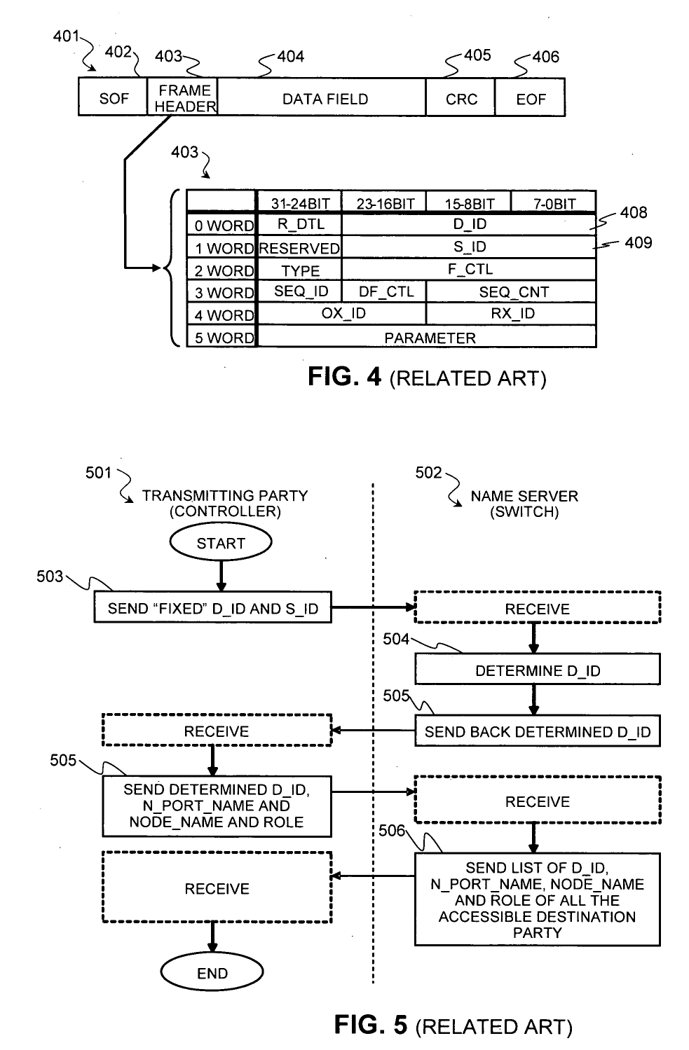

Under the Fibre Channel protocol, communication is executed by information of a signal level referred to as an “Ordered Set” and logical information having a fixed format referred to as a “frame”. FIG. 4 shows typical a structure of an FC frame. The frame 401 has 4-byte identification data representing the start of the frame (SOF) 402, a 24-byte frame header 403 characterizing control of a link operation and the frame, a data field 404 as a data part as the object to be actually transferred, a 4-byte cyclic redundancy code (CRC) 405 and a 4-byte identification data called end of frame (EOF) 406, which signals the end of the frame. The data field 404 is variable between 0 to 2112 bytes.

Next, the content of the frame header 403 will be explained. FIG. 4 includes a detailed structure of the frame header 403. Here, it is illustrated that D_ID 408 and S_ID 409 correspond to bit areas 0 to 23 of the first and second words in the detailed structure of the frame header 403. D_ID (Destination ID) 408 and S_ID (Source ID) 409 are 3-byte address identification data for identifying the port receiving the frame and the port transmitting the frame respectively, and have values effective for all the frames to be transmitted and received. Fibre Channel standard FC-PH stipulates that the fabric allocate D_ID and S_ID during the initialization procedure. The allocated value depends on N_Port_Name or Node_Name of each port.

Next, a typical login procedure using the Fibre Channel protocol will be described. Initially, after a fabric-capable Fibre Channel device is connected to a fabric switch, it will carry out a fabric login (FLOGI). Similar to a port login (PLOGI described below), FLOGI is an extended link service command that sets up a session between two participants. With FLOGI a session is created between an N_Port or NL_Port and the switch. An N_Port will send an FLOGI frame that contains its Node Name, its N_Port Name, and service parameters. FIG. 5 shows the exchange of information for an FCP port login (PLOGI) between a transmitting party 501 (a login requesting party, which may be correlated to the controller 103 in this invention, and particularly to the disk control portion 111 of controller 103) and a name server 502 (which may be correlated to the switch 112 in this invention).

The explanation will be given as a Class 3 login, though several kinds of login procedures are available in the Fibre Channel protocol (FCP). First, as illustrated in step 503, the transmitting party 501 transmits a PLOGI frame having a header containing fixed D_ID (0xFFFFFE), fixed S_ID (0x000000), and N_Port_Name and Node_Name of the transmitting party. Then, in step 504, the name server 502 determines the D_ID for the transmitting party 501 based on FC_PH, and, in step 505, sends back the determined D_ID to the transmitting party 501. After receiving the D_ID, the transmitting party 501 treats the D_ID as its own D_ID, and transmits a PLOGI frame with its own D_ID, N_Port_Name and Node_Name to the name server 502. In response to that, the name server 502 sends back a list of D_IDs, N_Port_Names and Node_Names of all the accessible destination parties (corresponding to the HDDs 114 as applied to the present invention). So, the transmitting party 501 always retains a list showing the correspondence of D_ID and N_Port_Name (WWN) for each destination party.

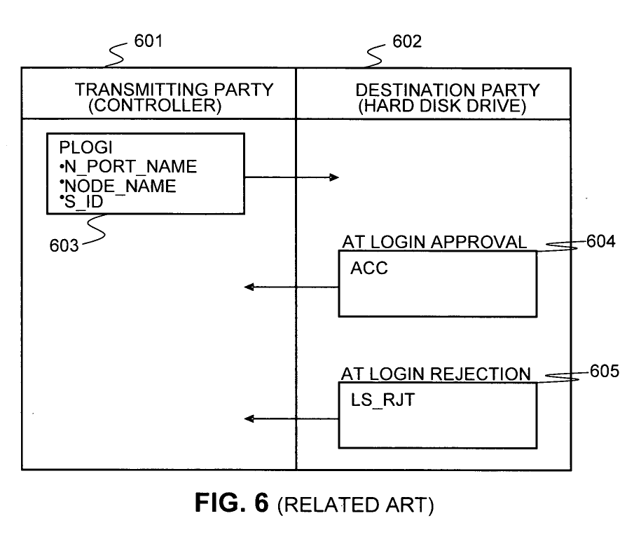

Next, the login procedure of equipment of the transmitting party and the destination party for mutually exchanging information on the basis of the Fibre Channel protocol will be described. FIG. 6 shows the exchange of information between the transmitting party. 601 (login requesting party, which may be correlated to the disk control portion 103, as applied to the present invention, and more particularly, to the disk control portion 111 of controller 103) and the destination party 602 (login receiving party, which may be correlated to the HDDs 114, as applied to the present invention).

The login requesting party transmits a PLOGI frame 603 to the login receiving party. This frame contains N_Port_Name, Node_Name, S_ID and other information of the login requesting party. Equipment at the destination, e.g., the CPU 201 in the HDD 114, based on the information contained in this frame, and determines whether to approve or reject the login attempt. When approving the login, the CPU 201 of HDD 114 transmits a frame called “ACC” 604 to the login requesting party. To reject login, on the other hand, it transmits a frame called “LS_RJT” 605 to the login requesting party.

When the transmitting party (controller 103) receives the response of the ACC frame in response to the PLOGI frame, the controller 103 knows that login was successful, and knows that it can now start an I/O process such as data transfer. When receiving LS_RJT frame 605, on the other hand, the controller 103 knows that login with the HDD 114 has not been established, and that I/O process to the corresponding login receiving party cannot be executed. Further, though the explanation has been provided for a login operation of Class 3, the information in other login processes that can be transmitted from a login requesting party to a login receiving party similarly contain N_Port_Name, Node_Name and S_ID, or their equivalents.

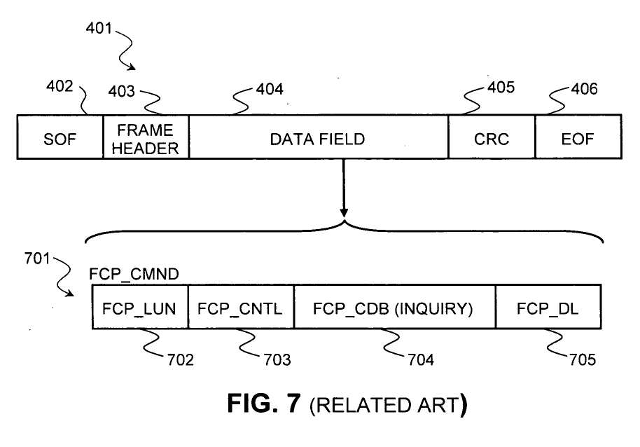

Next, an inquiry command that is a standard FCP command and is always supported in the SCSI command set will be explained. The inquiry command inquires to a logical unit as the object of the I/O process its package state and its preparation condition. FIG. 7 shows a detailed structure of the data field when the frame of the Fibre Channel standard transmits the Inquiry command defined by the SCSI standard. The basic structure of the frame and the frame header is analogous to the one shown in FIG. 4. Therefore, the structure contains S_ID 409.

The data field 404 includes areas called FCP_LUN 702, FCP_CNTL 703, FCP_CDB 704 and FCP_DL 705 as represented by an FCP_CMND format 701. FCP_LUN 702 stores identification data of a logical volume associated with the port of the frame transmission destination that the frame transmitting party is to inquire. Incidentally, the term “logical volume” or “logical unit” represents a storage area virtually divided and numbered for convenience sake for a storage device (physical volume) as a visible entity. The identification data is called “LUN” (Logical Unit Number). HDDs usually have only one logical unit, so the data in FCP_LUN 702 is always the same. FCP_CDB 704 stores command information called “command description block” (CDB) of SCSI protocol when the SCSI command set is used. This FCP_CDB 704 stores the inquiry command information of SCSI, and the information is transferred with FCP_LUN 702 to the frame receiving party. In other commands supported by the SCSI command set such as a Write command and Read command, too, the frame has the structures of 401 and 701 in the same way as the inquiry command. Therefore, these commands also contain an S_ID that may be used for executing the first embodiment.

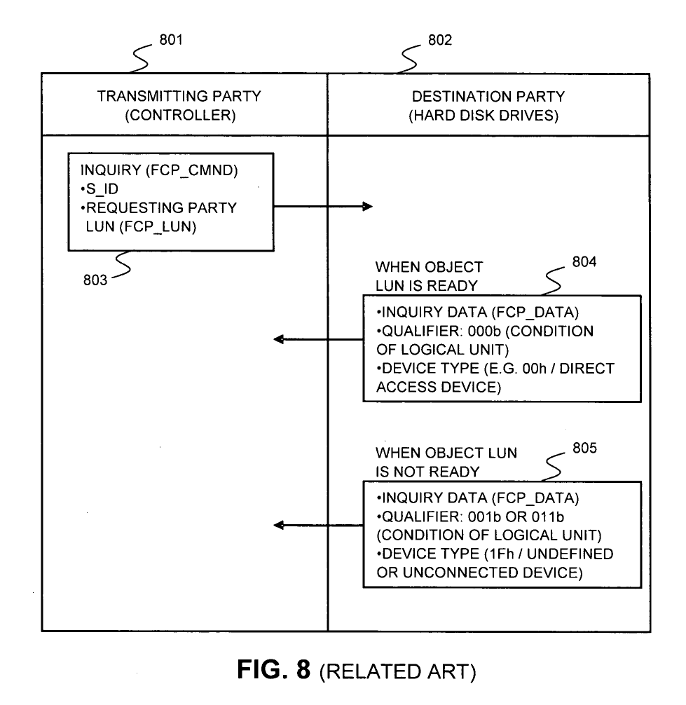

FIG. 8 shows the inquiry sequence of the logical unit by using the Inquiry command. A controller 801 that is to gain access to the logical unit transmits the frame 803 storing the inquiry command to an HDD 802 having the logical unit to be accesses. This frame contains S_ID of the controller and LUN as the identification data of the logical unit to be inquired. Here, LUN can be set into the format of the inquiry command information inside FCP_CDB besides the FCP_LUN area. The effect obtained is the same no matter which of these values is used.

Receiving the frame containing the inquiry command, the HDD 802 prepares inquiry data necessary for the inquiry and transmits a frame 804 containing the generated Inquiry data to the controller. In this instance, the frame storing the inquiry data is called “FCP_DATA”. When the HDD sets either a qualifier 000b (binary digit) or device type 00h to 09h (hexadecimal digit) for the logical unit inquired like 804, the controller that receives this inquiry data can subsequently generate I/O for this logical unit. As presented by 805, on the other hand, when the HDD sets a qualifier 001b (binary digit) or 011b (binary digit) or device type 1Fh (hexadecimal digit), the controller that receives this inquiry data 805 recognizes that subsequent generation of I/O is not possible. Therefore, it can be understood that when the HDD controls the qualifier and the device type code stored in the inquiry data, approval/rejection of the access from the controller to the logical unit of the HDD can be controlled.

As described above, the method of generating the frame is basically the same in the Write command and the Read command as in the Inquiry command. Therefore, when the controller on the side of the transmission destination detects S_ID designated by the transmitting controller as being illegal, access rejection can be realized.

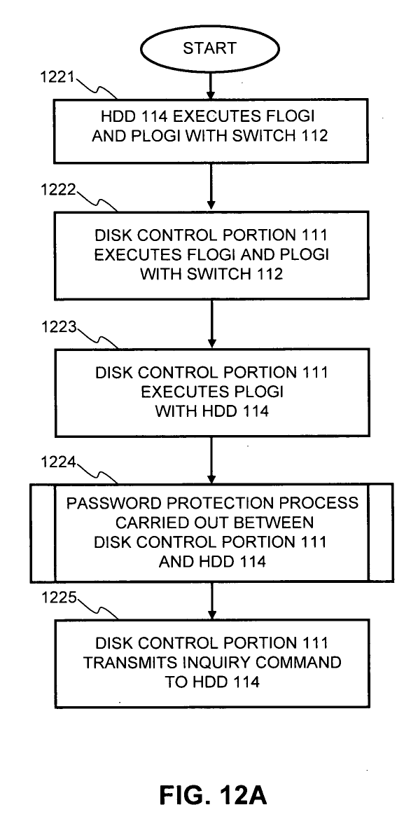

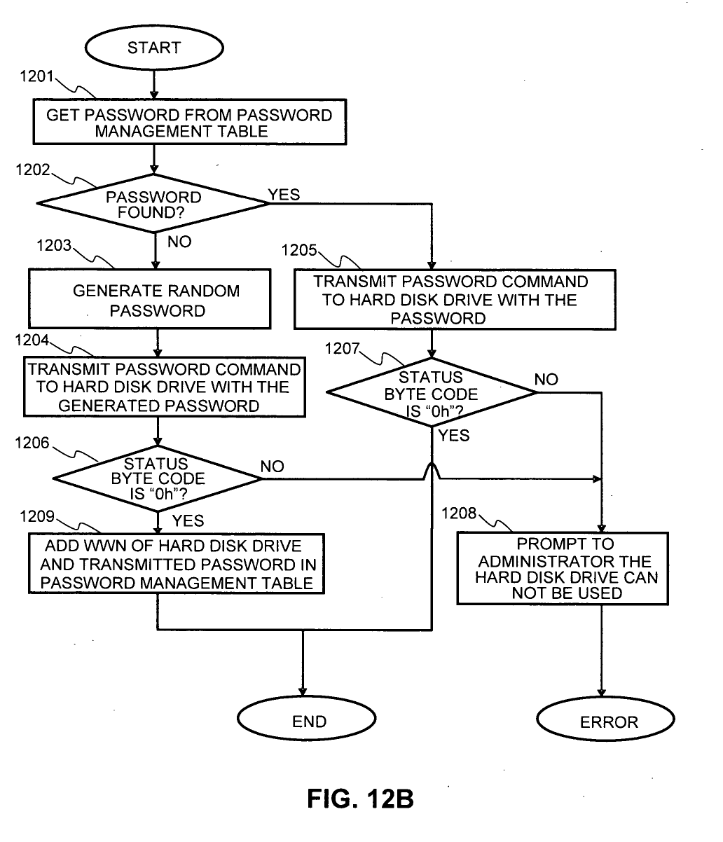

Accordingly, as illustrated in FIG. 12 A, under the Fibre Channel protocol, the sequence for accessing an HDD by a controller generally includes the steps of:

Step 1221: Each hard disk drive 114 (destination party) executes FLOGI and PLOGI processes with switch 112 (name server).

Step 1222: Disk control portion 111 (transmitting party) executes FLOGI and PLOGI processes with switch 112 (name server);

Step 1223: Disk control portion 111 (transmitting party) executes PLOGI with hard disk drive 114 (destination party); and

Step 1225: Disk control portion 111 (transmitting party) executes an INQUIRY command with hard disk drive 114 (destination party).

As will be described in more detail below, under the first embodiment of the invention, an additional step 1224 may be carried out wherein a password command can be sent to the HDDs 114, prior to step 1225 above, and if a password command is not sent, then the HDDs can be controlled so as to reject an inquiry command. This step is set forth in detail in FIG. 12B below.

Password Management

As described above, the password manager 301 in the controller 103 stores and manages the password management table 1000 illustrated in FIG. 10 in the nonvolatile memory 107. Using the password management table 1000, the controller 103 manages the correspondence between each HDD 114 and each password. More specifically, the controller 103 stores the WWN of each HDD 1001 and the password 1002 for the HDD 114 in table 1000. For example, row 1003 shows that the password is “A3GH4TIS” for the HDD whose WWN is “10:00:00:00:00:00:00:01”, and row 1004 shows the password is “4T5KLKA” for the HDD whose WWN is “10:00:00:00:00:00:00:02”.

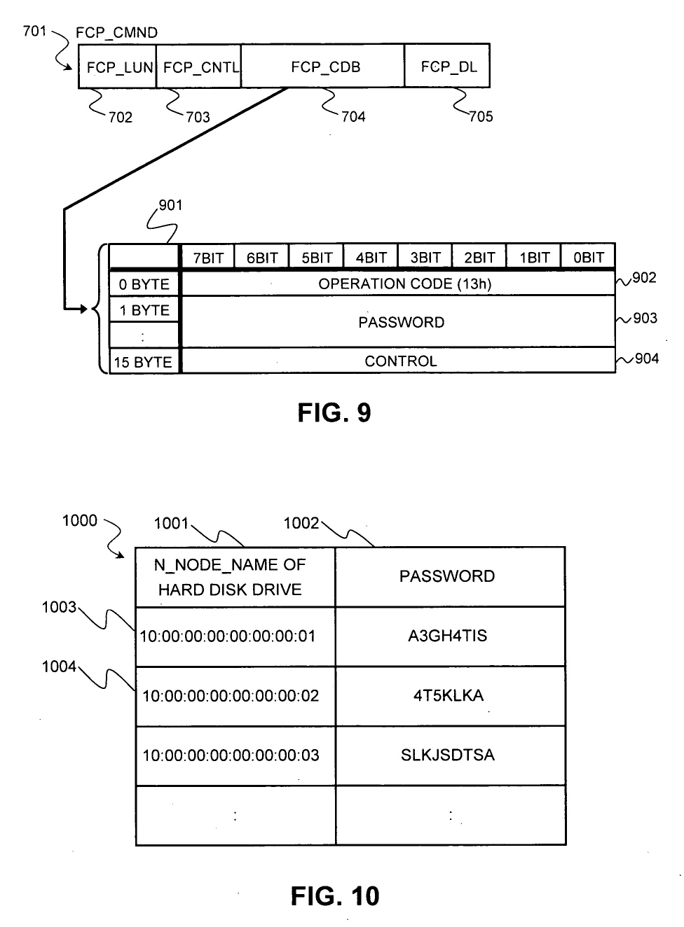

After the login procedure is completed (steps 1221-1223), before the controller 103 transmits the inquiry command to an HDD 114 (step 1225), the password manager 301 transmits a password command to the HDD 114. FIG. 9 shows an example of the structure 901 of FCP_CDB of the password command. The operation code 902 is a specific number assigned for each command. In this example, 13h (hexadecimal digit) is used to indicate the password command. The password field 903 contains the password for setting the password for the particular HDD 114, or for use to transmit the password to the particular HDD 114 to gain access. The control field 904 is a common control field for all the SCSI commands.

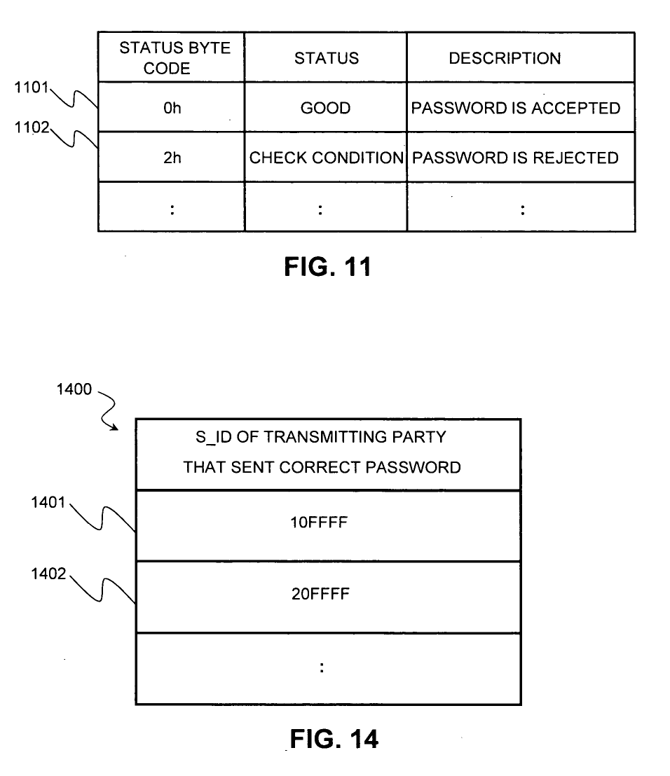

In response to the password command, the HDDs 114 that receive this command return a status byte code described in FIG. 11 conforming to a SCSI standard. If the password matches the password that the HDD 114 memorized (i.e., has stored in the nonvolatile memory 205, or on the physical disk 202), the destination party returns the status byte code “0h” (status GOOD). This means “password is accepted” in the present invention. Also, if the password has not yet been set, and if the HDD 114 memorizes the password sent from the controller 103 successfully, the destination party also returns the status byte code “0h”. However, if the particular password does not match the password that the particular HDD 114 memorized, or if the HDD 114 fails to memorize the password sent from the transmitting party, the HDD 114 returns the status byte code “2h” (status CHECK CONDITION), which means “password is rejected” in the present invention.

FIG. 12B shows the flow diagram of the password management process of step 1224 from FIG. 12A in the password manager 301. This flow runs after the controller 103 successfully logged in an HDD 114 with PLOGI (steps 1221-1223), and before the controller 103 transmits the inquiry command to the HDD 114 (step 1225).

In step 1201, the password manager 301 tries to retrieve the password for the HDD 114 by searching the password management table 1000 by using N_Port_Name (WWN) of the HDD 114 as a key. In step 1202, if the password manager 301 identified a password for the HDD 114, then in step 1205, the password manager 301 transmits the password command with the password to the HDD 114. If the status byte code returned from the HDD 114 is “0h”, it means that the password is accepted by the HDD 114, and the process is successfully done. The controller 103 then transmits the inquiry command to the HDD 114. But if the status byte code returned from the HDD 114 is not “0h” (that means “2h”), it means that the HDD 114 rejected the password. In that case, in step 1208, the password manager 301 prompts to the administrator of the disk array system 100 that the HDD 114 can not be accessed. In step 1202, if the password manager 301 could not find a password for the HDD 114, then in step 1203, password manager 301 generates a random password. Next, in step 1204, the password manager 301 transmits the password command with the generated password to the HDD 114. If the status byte code returned from the HDD 114 is “0h”, it means that the password is memorized by the HDD 114. Then in step 1209, the controller 103 adds the pair of WWN of the HDD 114 and the generated password into the password management table 1000, and the controller 103 then transmits the inquiry command to the HDD 114. But if the response returned from the HDD 114 is not “0h” (that means “2h”), it means that the HDD 114 failed to memorize the password, or rejected the password because the HDD 114 has memorized a different password already. In that case, in step 1208, the password manager 301 prompts to the administrator of the disk array system 100 that the particular HDD 114 that returned the “2h” status code response can not be accessed.

Response to Password Command

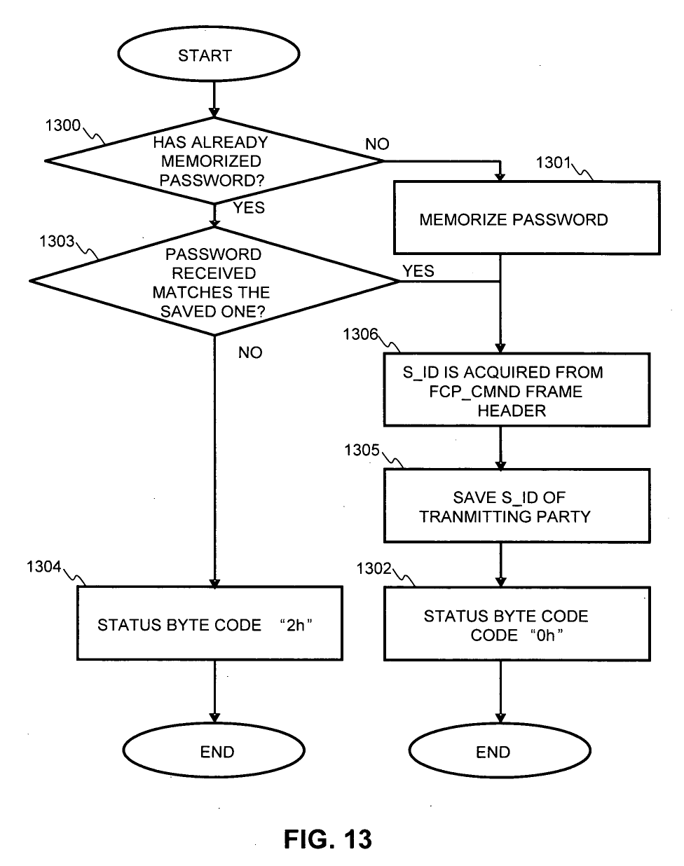

FIG. 13 shows the flow diagram of processing the password command in the HDD password memorizing module 302 in the HDD 114. When the HDD 114 receives the password command, as in step 1300 (corresponding to step 1204 or 1205 of FIG. 12B), password memorizing module 302 checks whether a password is already memorized (stored) in the nonvolatile memory 205. If a password is not yet memorized, then in step 1301, the HDD memorizing module 302 memorizes the password in the password command transmitted from the controller 103. Then in step 1305, the HDD memorizing module 302 acquires the S_ID of the transmitting party of the password command from the FCP_CMND frame header, and in step 1306, saves the S_ID in the “password accepted list” 1400 in FIG. 14. Then in step 1302, the HDD memorizing module 302 returns the status byte code “0h” (password is accepted) to the controller 103 (corresponding to step 1206 of FIG. 12B). If the HDD password memorizing module 302 has already stored a password in the nonvolatile memory 205, then in step 1303, HDD memorizing module 302 checks whether the password in the password command transmitted from the controller 103 matches the memorized one. If the two passwords match, then in step 1305, the HDD memorizing module 302 acquires the S_ID of the transmitting party of the Password command from the FCP_CMND frame header, and in step 1306, saves the S_ID in the “password accepted list” 1400 in FIG. 14. Then in step 1302, the HDD memorizing module 302 returns the status byte code “0h” (password is accepted) to the controller 103 (corresponding to step 1207 of FIG. 12B). If the passwords do not match, then in step 1304, the HDD memorizing module 302 returns the status byte code “2h” (password is rejected) to the controller 103 (also corresponding to step 1207 of FIG. 12B).

Inquiry Command Response:

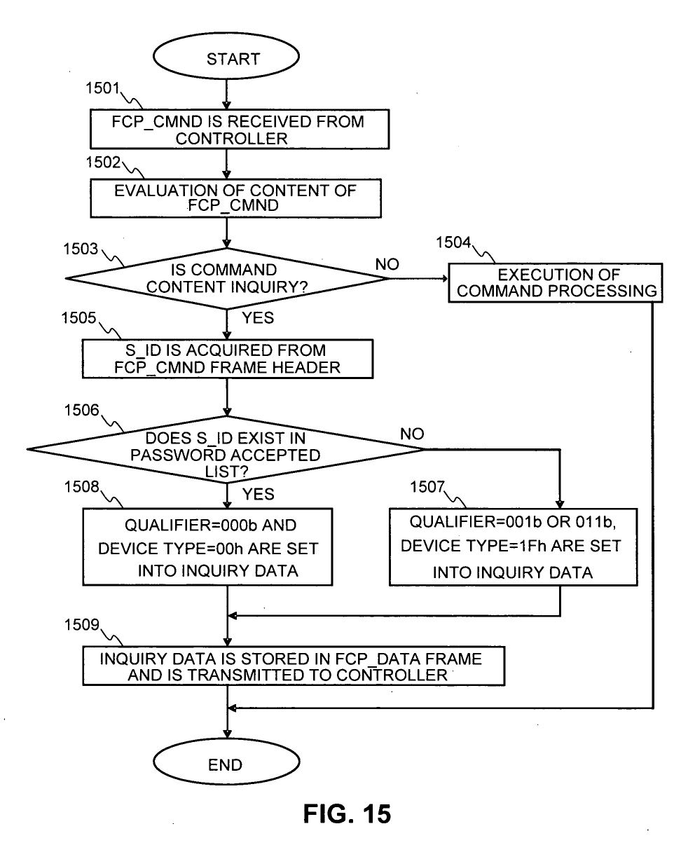

FIG. 15 shows the flow diagram of the processing of the Inquiry command in the HDDs 114. When, in step 1501, the HDD 114 receives the FCP_CMND from the controller 111, CPU 201 evaluates the content of the FCP_CMND in step 1502. In step 1503, if the command included in FCP_CMND is not the Inquiry command, then in step 1504, the HDD 114 executes the command processing. If the command is the inquiry command, then in step 1505, the HDD 114 acquires the S_ID of the transmitting party of the inquiry command from FCP_CMND frame header. Then in step 1506, the HDD 114 checks if the S_ID exists in the “password accepted list” 1400. If the S_ID exists, then in step 1508, the HDD 114 sets 000b for the value of qualifier and 00h for the value of device type in the inquiry data. If the S_ID doesn't exist, then in step 1507, the HDD 114 sets 001b or 011 b for the value of qualifier and 1Fh for the value of device type in the inquiry data. Then in step 1509, the inquiry data is stored in FCP_DATA frame and is transmitted to the controller 103. Thus, after the controller 103 receives the inquiry data, if QUALIFIER=000b and DEVICE TYPE=00h are set in the inquiry data, the controller 103 recognizes that the LU in the hard drive is accessible from the controller. But if QUALIFIER=001b or 011b and DEVICE TYPE=1Fh are set, the controller thinks that the LU in the hard drive is not accessible. The foregoing demonstrates how after the password has been accepted by the HDD 114, the password does not have to be resent with each access request from controller 103, since the HDD is able to check to determine if the controller 103 has already sent the password by checking whether the S_ID exists in the password accepted list 1400.

Second Embodiment

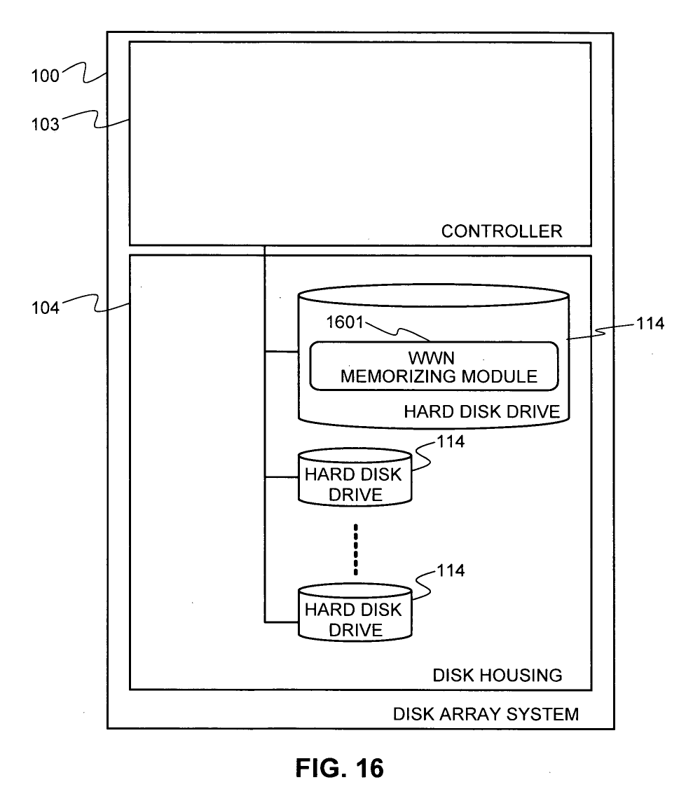

The system configuration for the second embodiment may be the same as that illustrated in FIG. 1, with respect to the first embodiment. FIG. 16 shows a functional diagram of the disk array system 100 in the second embodiment. In the controller 103, an additional module (such as a password manager) is not required. However, in each of the HDDs 114, there is a WWN memorizing module 1601. The WWN memorizing module 1601 memorizes the WWN of the controller 103 by storing the WWN in the nonvolatile memory 205 in the HDD 114. After memorizing a WWN, the WWN memorizing module 1601 allows access only from the controller having the same WWN as the WWN that the WWN memorizing module 1601 memorized.

Flow Diagram of Processing Login Request in HDD:

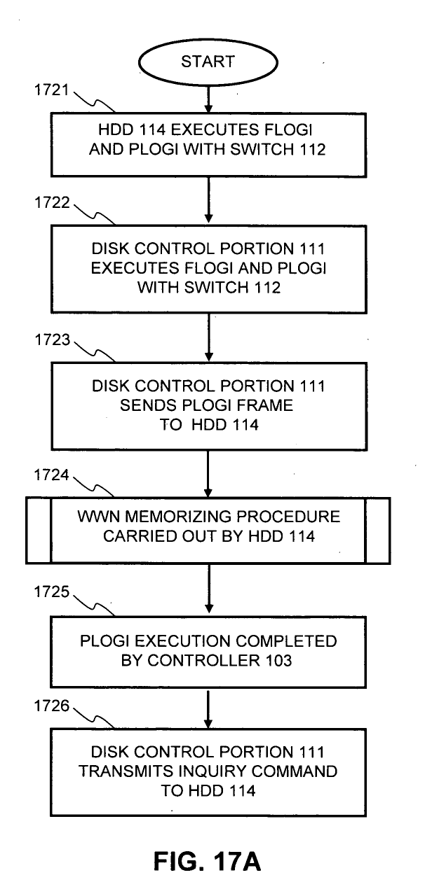

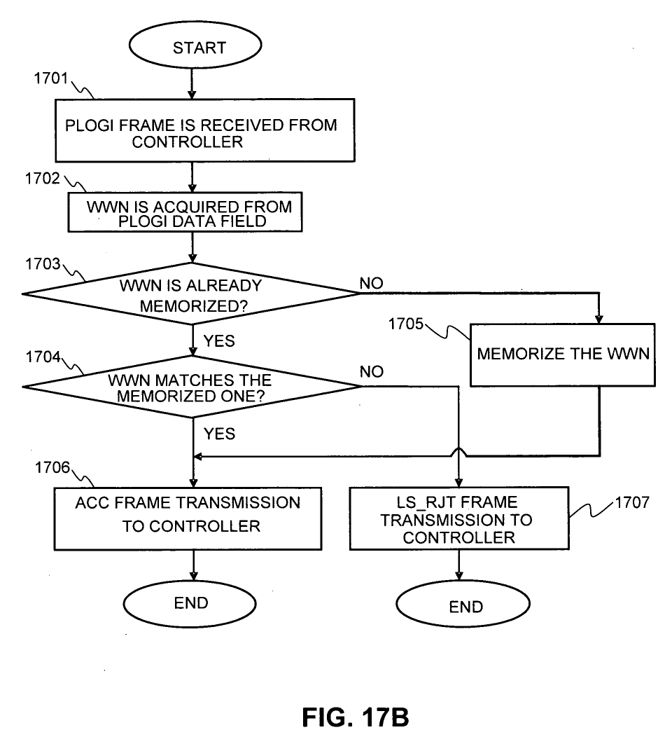

As illustrated in FIG. 17A, under the second embodiment, the sequence for accessing an HDD by a controller is similar to that for the first embodiment, except that the WWN of the controller is memorized by the HDD during the PLOGI procedure. The sequence generally includes the steps of:

Step 1721: Each hard disk drive 114 (destination party) executes FLOGI and PLOGI processes with switch 112 (name server).

Step 1722: Disk control portion 111 (transmitting party) executes FLOGI and PLOGI processes with switch 112 (name server);

Step 1723: Disk control portion 111 (transmitting party) sends a PLOGI frame to hard disk drive 114 (destination party); and

Step 1724: The HDD memorizes the WWN of the disk control portion 111, or accepts the WWN as one already memorized, or sends back a rejection. This step is set forth in detail in FIG. 17B below.

Step 1725: Disk controller 103 completes PLOGI execution.

Step 1726: Disk control portion 111 (transmitting party) executes an INQUIRY command with hard disk drive 114 (destination party).

FIG. 17B shows a flow diagram of the process for memorizing a WWN in the WWN memorizing module 1601 when the HDD 114 receives the login (PLOGI) request. In step 1701, when the HDD 114 receives a PLOGI frame from the controller 103, then in step 1702, it acquires the WWN (N_Port_Name) from the PLOGI data field. Then in step 1703, the HDD 114 checks if it has already memorized a WWN in the nonvolatile memory 205 or in the physical disk 202. If the HDD 114 has not memorized any WWN yet, then in step 1705, WWN memorizing module stores the WWN acquired from the PLOGI data field in the nonvolatile memory 205, or in the physical disk, or both. Then in step 1706, the HDD 114 transmits the ACC frame to the controller 103 to approve the login. If the HDD 114 has already memorized a WWN before, then in step 1704, the check is made to determine if the WWN acquired from the PLOGI data field matches the memorized WwN. If the two WWNs match, then in step 1706, the HDD 114 transmits the ACC frame to the controller 103 to approve the login. If the two WWNs do not match, then in step 1707, the HDD 114 transmits the LS_RJT frame to the controller 103 to reject the login. If the controller 103 receives an LS_RJT frame, a prompt or error message may be sent to a system administrator indicating that the HDD that sent the LS_RJT frame cannot be used.

Third Embodiment:

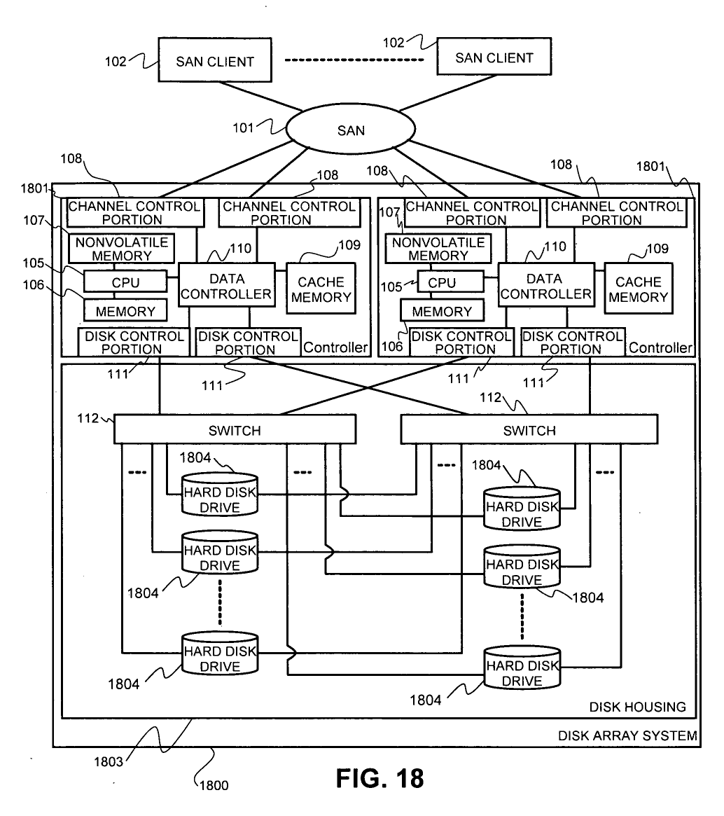

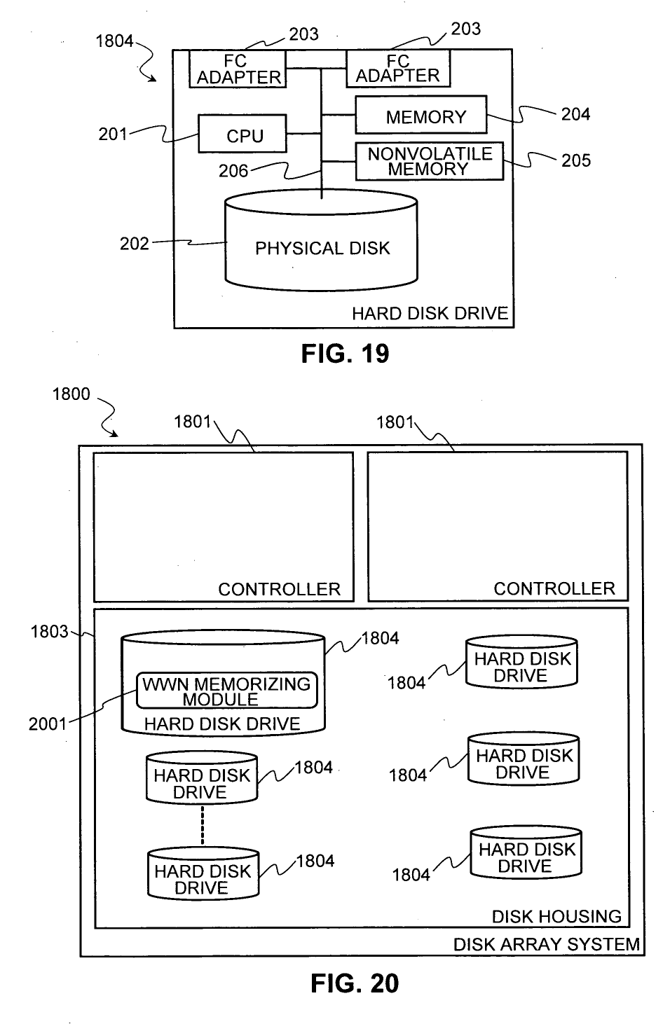

FIG. 18 illustrates an example of a disk array system in which the third embodiment of the invention is applied. As illustrated in FIG. 18, the components that comprise the disk array system 1800 in third embodiment are almost the same as those in first embodiment. However, the disk array system 1800 has two controllers 1801 so that th SAN clients 102 can access the data in HDDs 1804 even if one of the controllers 1801 failed. Also, each of the controllers 1801 has two disk control portions 111 and two switches 112, so that the CPU 105 of each controller can access the data in HDDs 1804 even if one of the disk control portions 111 or the switches 112 failed. To connect to the multiple switches, as shown in FIG. 19, each HDD 1804 has two FC adapters 1901.

FIG. 20 shows a functional diagram of the disk array system 1800 in FIG. 18. In the controller 100, there is no additional module needed. In each of the HDD 1904, there is a WWN memorizing module 2001. The WWN memorizing module 2001 memorizes the predetermined number of WWNs in the nonvolatile memory 205 in the HDD 1904. The number can be determined, for example, based on the number of the disk control portions 1801 connected to the HDDs 1804. After memorizing the predetermined number of WWNs, the WWN memorizing modules 1801 allows the access only from the disk control portions that have the same WWN as the one of the WWNs that the WWN memorizing module 2001 memorized.

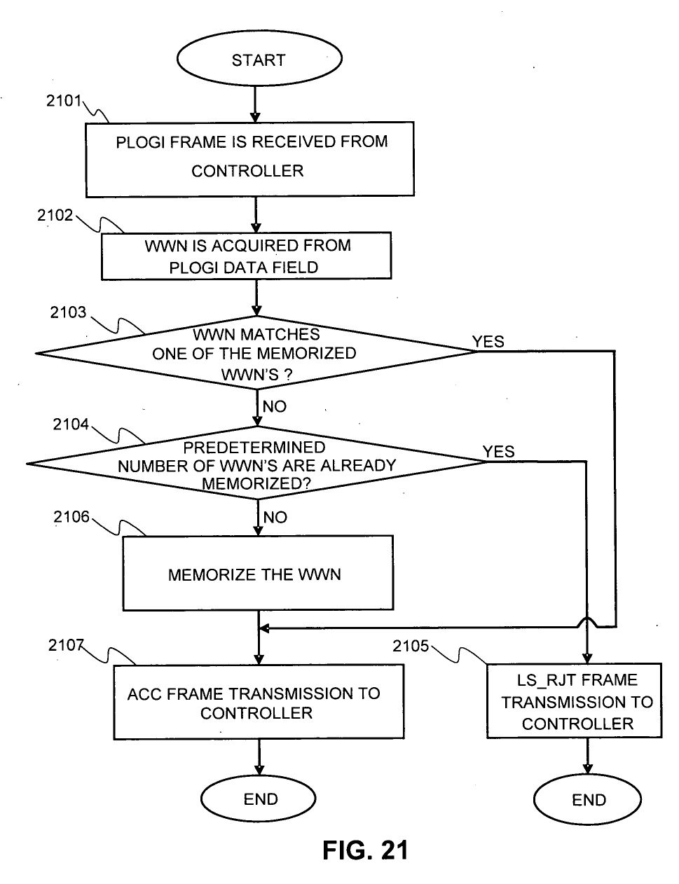

The initial access procedure for the third embodiment is the same as for the second embodiment, as set forth in FIG. 17A. However, the process is carried out for each controller 1801 that wants to login to each HDD 1804. Further, rather than carrying out the process flow set forth in FIG. 17B for step 1724, the process flow of FIG. 21 is carried out. FIG. 21 shows the flow diagram of memorizing a WWN in the WWN memorizing module 2001 when the HDD 1804 receives the login (PLOGI) request. In step 2101, when the HDD 1804 receives PLOGI frame from the controller 1801, then in step 2102, it acquires the WWN (N_Port_Name) from the PLOGI data field. Then in step 2103, the check is made to determine if the WWN acquired from the PLOGI data field matches any of the memorized WWNs. If it matches, in step 2107, the HDD 1804 transmits the ACC frame to the controller 1801 to approve the login. If it does not match, then in step 2104, the HDD 1804 checks if it has already memorized a predetermined number of WWNs in the nonvolatile memory 205. If the HDD 1804 has not yet memorized the predetermined number of WWNs yet, then in step 1705, the memorizing module 2001 memorizes the WWN acquired from the PLOGI data field. Then, in step 2107, the HDD 1804 transmits the ACC frame to the controller 1801 to approve the login. If the HDD 1804 has already memorized the predetermined number of WWNs before, then in step 2105, the HDD 1804 transmits the LS_RJT frame to the controller 1801 to reject the login.

Thus, by the foregoing systems, methods, and apparatuses, it will be apparent to those skilled in the art that the present invention provides a means for preventing unauthorized access to a hard disk drive that is removed from a disk array system and attempted to be accessed by another access device, such as another disk controller, computer, or the like.

From the foregoing, it will be apparent to those skilled in the area of the invention that the present invention provides a system, method, and apparatus for protecting data stored on HDDs used within the a disk array system, and if those HDDs are removed from the disk array system, access to the data will be prevented. Further, while specific embodiments have been illustrated and described in this specification, those of ordinary skill in the art will appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A method of controlling access to data stored in hard disk drives in a disk array system having a disk controller and a plurality of said hard disk drives in communication with said disk controller, said method comprising:
generating, by said disk controller, a password for each said hard disk drive in said disk array system;
sending, by said disk controller, a command to each said hard disk drive, said command including a respective password generated for respective hard disk drives;
checking by each said respective hard disk drive receiving said command whether a password is already stored by said respective hard disk drive, and if no password is stored, storing by said respective hard disk the respective password generated for that respective hard disk drive.

2. The method of claim 1, further including the step of:
preventing access to any particular one of the hard disk drives unless the respective password generated for that particular hard disk drive is transmitted to the hard disk drive by said command.

3. The method of claim 1, further including the step of:
storing in a password management table the world wide name (WWN) of each said hard disk drive, and the respective password generated for each said hard disk drive.

4. The method of claim 1, further including the step of:
providing each said hard disk drive with a CPU and software for execution by the CPU stored in a nonvolatile memory in each said disk drive that causes the CPU to check whether a password is already stored by that hard disk drive.

5. The method of claim 1, further including the step of:
transmitting to each hard disk drive by the disk controller a password command including a respective password for each respective hard disk drive prior to sending an inquiry command.

6. The method of claim 1, further including the step of:
storing by the hard disk drive a source identification of the controller that sent the command to the hard disk drive.

7. A method for controlling access to a hard disk drive, said hard disk drive having a nonvolatile memory, a CPU, and a local disk, and being at least initially located in a disk array system, said method comprising:
memorizing, by said hard disk drive, a world wide name (WWN) of a disk controller of the disk array;
whereby, an attempt to access said hard disk drive by a device having a different WWN from the memorized WWN will be rejected by the hard disk drive.

8. The method of claim 7, further including the step of:
providing a plurality of disk controllers in communication with said hard disk drive, each said disk controller having its own WWN;
wherein the hard disk drive stores the WWN of each said controller up to a predetermined number, and thereafter only allow initialization by a device having a WWN that matches of said WWNs stored by the hard disk drive.

9. The method of claim 7 further including the step of:
providing a plurality of said hard disk drives, wherein each hard disk drive memorizes the WWN of the disk controller.

10. The method of claim 8 further including the step of:
providing a plurality of said hard disk drives, wherein each hard disk drive memorizes the WWN of each of the disk controllers up to a predetermined number.

11. The method of claim 7, further including the step of:
providing said hard disk drive with a CPU and a nonvolatile memory storing software, which when executed by the CPU causes the hard disk drive to acquire the WWN from a command received from the disk controller.

12. The method of claim 11, further including the step of:
acquiring the WWN from a login command frame sent by the disk controller.

13. A storage system comprising:
at least one hard disk drive, said hard disk drive including a world wide name (WWN) memorizing module and a CPU for controlling access to the hard disk drive; and
at least one access device in communication with the disk drive, said access device having a WWN,
wherein, said hard disk drive memorizes the WWN of the access device and thereafter only permits access by an access device having a WWN that matches the WWN which was memorized.

14. The system of claim 13, wherein:
there are multiple access devices, each having a different WWN, and said hard disk drive memorizes the WWNs of the multiple access devices up to a predetermined number, and thereafter only permits access by a device having a WWN that matches one of the WWNs which were memorized.

15. The system of claim 13, wherein:
the access device is a disk controller in a disk array system.

16. The system of claim 13, further wherein:
said hard disk drive includes a CPU and a nonvolatile memory storing software, which when executed by the CPU causes the hard disk drive to acquire the WWN from a command received from the access device.

17. The system of claim 16, wherein:
the WWN is acquired from a login command frame sent by the access device.

18. The system of claim 16, wherein:
there are multiple access devices, each having a different WWN, and said hard disk drive memorizes the WWNs of the multiple access devices up to a predetermined number, and thereafter only permits access by a device having a WWN that matches one of the WWNs which were memorized.

19. The system of claim 13, wherein:
said access device sends a PLOGI frame to said hard disk drive to attempt access to the hard disk drive, said PLOGI frame including the WWN of the access device,
wherein if said hard disk drive has already memorized a WWN, the hard disk drive compares the WWN in said frame with the memorized WWN to determine whether to allow access by the access device, and
wherein if said hard disk drive has not already memorized a WWN, the hard disk drive stores the WWN included in said frame.

20. The system of claim 19, wherein:
said hard disk drive is able to memorize a predetermined number of WWNs and upon receiving said frame determines whether the WWN included in the frame has already been memorized,
wherein if the WWN has already been memorized the hard disk drive allows access by the access device,
wherein if the WWN has not already been memorized and the predetermined number has not yet been reached, the hard disk drive memorizes the WWN, and
wherein if the predetermined number has been reached, and the WWN does not match a WWN that the hard disk drive has memorized, access by the access device is rejected by the hard disk drive.
